(19) United States
(12) Patent Application Publication
(10) Pub. No.: US 2024/0140670 A1
(43) Pub. Date: May 2, 2024

(54) RECYCLABLE INSULATION MATERIAL, METHODS FOR MAKING, AND MACHINES FOR MAKING

(71) Applicant: TemperPack Technologies Inc., Richmond, VA (US)

(72) Inventors: Charles-Alexandre Archambault Vincent, Richmond, VA (US); James McGoff, Richmond, VA (US); Michael Scipione, Richmond, VA (US); Daniel Shores, Richmond, VA (US); Justin Turner-Gonzalez, Richmond, VA (US)

(21) Appl. No.: 18/548,710

(22) PCT Filed: Mar. 1, 2022
(86) PCT No.: PCT/US22/18358

§ 371 Date: Sep. 1, 2023

Related U.S. Application Data
(60) Provisional application No. 63/200,354, filed on Mar. 2, 2021.

(51) Int. Cl. B65D 65/40; B31D 5/00; B32B 29/00; B32B 29/08; B65D 81/38

(52) U.S. Cl. CPC B65D 65/403; B31D 5/006; B32B 29/005; B32B 29/08; B65D 81/3813; B31D 2205/0047; B31D 2205/0058; B31D 2205/0064; B32B 2250/26; B32B 2307/304; B32B 2553/00; B65D 2565/385

(57) ABSTRACT

The presently disclosed subject matter generally relates to recyclable insulation material for packaging, machines for making the recyclable insulation material, and methods for the making the recyclable insulation material.

### CROSS-REFERENCE TO RELATED APPLICATION

This application is a Patent Cooperation Treaty (PCT) application of and claims priority under Article 8 of the PCT to U.S. Provisional Patent Application No. 63/200,354 filed Mar. 2, 2021, the entirety of which is incorporated herein as if fully set forth below.

### FIELD

The presently disclosed subject matter generally relates to recyclable insulation material for packaging, machines for making the recyclable insulation material, and methods for the making the recyclable insulation material.

### BACKGROUND

Insulation materials have long been used in a variety of applications and are being increasingly used in insulated shipping containers to provide desired or required thermal environments when shipping goods. For example, an insulated shipping container transporting perishable goods (e.g., refrigerated meals) may increase the longevity of the goods and, in turn, expand the shipping area of the customer base. While some insulated shipping containers are designed for long term use, others are designed for a more limited lifespan in favor of lower materials and manufacturing costs. While these limited lifespan shipping containers practically serve their intended purpose, the ever-increasing volume of shipping containers results in higher levels of waste, most of which is non-recyclable at least in part because the insulation materials are often non-recyclable. Environmentally conscious retailers and consumers are faced with limited environmentally friendly and responsible options, much less cost-effective options, for disposing insulation materials or insulated shipping containers following use.

Accordingly, there is a need for recyclable insulation, machines for making recyclable insulation, and methods of making the recyclable insulation. Embodiments of the present disclosure are directed to this and other considerations.

### SUMMARY

Briefly described, embodiments of the presently disclosed subject matter relate to an insulation product, one or more machines for making the insulation product, and one or more methods for making an insulation product that insulates and/or cushions items for shipping. Specifically, in one aspect, an insulation product may include a substrate wound into a plurality of layers or piles. The substrate may include a first surface including a first embossed pattern and a second surface including a second embossed pattern opposite of and interior to the first surface. At least a first portion of the first surface and at least a second portion of the second surface may overlap (or be disposed adjacent to one another) such that the first embossed pattern and the second embossed pattern prevent the first surface and the second surface from nesting. The plurality of layers may be bound together to prevent from being unwound.

In other aspects, a machine for making an insulation structure may include an initial roller configured to accept a roll of a substrate. The machine may also include a tension control system configured to unwind the roll of the substrate at a first predetermined speed and align the substrate for embossing. The tension control system may include at least one tension roller. The machine may also include a first embossing roller configured to emboss a first surface of the substrate with a first predetermined pattern. The machine may also include a second embossing roller configured emboss a second surface of the substrate with a second predetermined pattern. The second surface may be opposite to the first surface with the second predetermined pattern. For example, the first embossing roller may emboss the first surface of the substrate with a positive imprint and the second embossing roller may emboss the second surface of the substrate with a negative imprint or vice versa. In some embodiments, the second embossing roller may include a flexible material (e.g., rubber) and may receive a positive or negative imprint from the first embossing roller. Regardless, the first embossing roller and the second embossing roller may emboss the substrate at a same time to create an embossed substrate at the first predetermined speed. The machine may also include a set of accumulation rollers configured to transition the embossed substrate from moving at the first predetermined speed to a second predetermined speed. The machine may also include a drum configured to wind the embossed substrate a predetermined number of times and at the second predetermined speed to create a wound and embossed substrate comprising a plurality of layers. The machine may also include a guillotine configured to cut and separate the wound and embossed substrate from the embossed substrate. The machine may also include an upper (second) conveyor belt and a lower (first) conveyor belt spaced a predetermined distance apart. The upper and lower conveyor belt may be configured to collapse the wound and embossed substrate to create a collapsed substrate structure. Finally, the machine may include a bonding system that may include one or more actuators attached to one or more pins. The one or more actuators may be configured to apply a predetermined amount of pressure to the collapsed substrate structure via the one or more pins against one or more anvils (e.g., one or more plates) to form one or more bonds between the plurality of layers.

In other aspects, a machine for making an insulation structure or product may include an initial roller configured to house a roll of a substrate. The machine may also include a pair of embossing rollers configured to emboss a first surface of the substrate with a first pattern and a second surface of the substrate a second pattern to create an embossed substrate. The machine may also include a first orbital gripper comprising a first spacer, a first driver connected to the first spacer, and a pair of first retractable grippers adjustably connected to the first spacer. The pair of first retractable grippers may be spaced apart by a first predetermined distance using the first spacer with the first driver disposed halfway between the pair of first retractable grippers. Each first retractable gripper is configured to grip a first end of the embossed substrate. The machine may also include a second orbital gripper comprising a second spacer, a second driver connected to the second spacer, and a pair of second retractable grippers adjustably connected to the second spacer. The pair of second retractable grippers may be spaced apart by a second predetermined distance using the second spacer with the second driver disposed halfway between the pair of second retractable grippers. Each second retractable gripper may be configured to grip a second end of the embossed substrate that is distal to the first end of the embossed substrate. The first orbital gripper and the second orbital gripper may be configured wind the embossed substrate to create a wound substrate comprising a plurality of layers by simultaneously rotating the first driver and the second driver.

In other aspects, a method for making an insulation structure may include unwinding a roll of a substrate at a first predetermined speed and embossing a first surface of the substrate with a first predetermined pattern and a second surface of the substrate that is opposite of the first surface with a second predetermined pattern to create an embossed substrate at the first predetermined speed. The method may also include winding the embossed substrate around a drum at a second predetermined speed to create a wound and embossed substrate comprising a plurality of layers. The method may also include removing the wound and embossed substrate from the drum. The method may also include separating the wound and embossed substrate from the embossed substrate by cutting the embossed substrate to create a wound substrate structure and collapsing the wound substrate structure to create a collapsed substrate structure. Finally, the method may include bonding the plurality of layers of the collapsed substrate structure at one or more bond points.

In other aspects, a method for making an insulation structure may include unwinding a roll of a substrate at a first predetermined speed and embossing a first surface of the substrate with a first predetermined pattern and a second surface of the substrate that is opposite of the first surface with a second predetermined pattern to create an embossed substrate at the first predetermined speed. The method may also include winding the embossed substrate at a second predetermined speed to create a wound and embossed substrate comprising a plurality of layers. The method may also include separating the wound and embossed substrate from the embossed substrate by cutting the embossed substrate to create a wound substrate structure. Finally, the method may also include bonding the plurality of layers at one or more bond points.

The foregoing summarizes only a few aspects of the presently disclosed subject matter and is not intended to be reflective of the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

### BRIEF DESCRIPTION OF THE DRAWINGS

FIG. 1A is a perspective view of an insulation product according to an exemplary embodiment.

FIG. 1B is an enlarged top view the insulation product shown in FIG. 1A.

FIG. 2A is a perspective view of a model of another insulation product according to an exemplary embodiment.

FIG. 2B is a perspective view and an enlarged perspective view of a sample of an insulation product according to an exemplary embodiment.

FIGS. 3A-3L are images of various embossing patterns suitable for the insulation product according to various exemplary embodiments.

FIGS. 3M-3AF are diagrams of various exemplary embossing patterns for the insulation product according to various exemplary embodiments.

FIGS. 4A-4M are various views of a machine for making the insulation product according to an exemplary embodiment.

FIG. 4N is schematic diagram of another machine for making the insulation product according to an exemplary embodiment.

FIG. 4O is schematic diagram of another machine for making the insulation product according to another exemplary embodiment.

FIG. 4P is a schematic diagram of another machine for making the insulation product according to another exemplary embodiment.

FIGS. 4Q and 4R illustrate machine 400e making the insulation product 100 according to another exemplary embodiment.

FIG. 4S is a schematic diagram of a bonding system according to an exemplary embodiment.

FIG. 4T is a schematic diagram of another bonding system according to an exemplary embodiment.

FIGS. 5A-5C are various view of another machine for making the insulation product according to an exemplary embodiment.

FIG. 6 is a flowchart of a method for making an insulation product according to an exemplary embodiment.

FIG. 7 is a flowchart of a method for making an insulation product according to another exemplary embodiment.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical range and sub-range is explicitly recited. For example, a range of approximately 1 to 99.99 should be interpreted to include not only the explicitly recited limits of approximately 1 and approximately 99.99, but also individual amounts such as 2, 3, 4, 5.01, 5.02, 99.98, etc., and sub ranges such as 5 to 80 and 30.21 to 83.24, etc. Similarly, it should be understood that when numerical ranges are provided, such ranges are to be construed as providing literal support for claim limitations that only recite the lower value of the range as well as claim limitations that only recite the upper value of the range. For example, a disclosed numerical range of 5 to 15 provides literal support for a claim reciting “greater than 5” (with no upper bounds) and a claim reciting “less than 15” (with no lower bounds).

Referring now to the figures, in which like reference numerals represent like parts, various embodiments of the disclosure will be disclosed in detail.

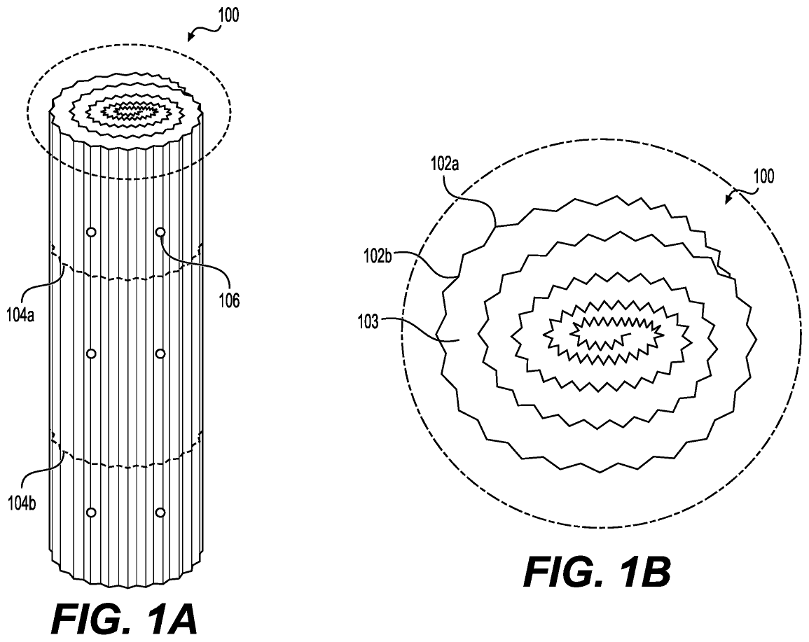

FIG. 1A is a perspective view of an insulation product according to an exemplary embodiment and FIG. 1B is a top view of the insulation product of FIG. 1A. As shown in FIGS. 1A and 1B, the insulation product 100 may include a substrate wound into a plurality of layers with each layer having a first predetermined thickness. Although FIGS. 1A and 1B illustrate the product 100 having a generally circular cross-section, the product 100 may have a more oval cross-section because the structure may be collapsed during processing.

In some embodiments, the number of layers is determined by analyzing the R-value, thickness, and other properties of the substrate. In addition, the number of layers are determined based on the impact that they number of layers have on thermal performance while balancing the need to have a light weight material. In some embodiments, the wound substrate will include 2 to 40 layers (e.g., 10 to 16 layers). Generally, the R-value and R-value per inch of thickness of the insulation product of exemplary embodiments is higher than that of other insulation products.

The substrate may include a first surface 102a having a first embossed pattern and a second surface 102b having a second embossed pattern opposite of and interior to the first surface 102a. At least a first portion of the first surface 102a and at least a second portion of the second surface 102b may overlap or be disposed to be adjacent to one another. The plurality of layers may be attached (e.g., bound) together to prevent the substrate from being unwound. For example, the plurality of layers may be bound with an adhesive, with a fastener, stitches, or combinations thereof. In other examples, the plurality of layers may be attached without an adhesive such as with pressure so that the plurality of layers bond at one or more points 106. The substrate may be one continuation sheet wound to form a plurality of layers. Each layer being roughly defined by its overlap. For example, one layer becomes the next layer when it begins to be disposed over or under the previous layer (e.g., it begins to overlap with the previous layer). As another example, one layer becomes the next layer when it with the previous layer with respect to a horizontal plane. As a further example, one layer becomes the next layer when it overlaps with the previous layer with respect to a vertical plane.

Although the at least the first portion of the first surface 102a and the at least the second portion of the second surface 102b may overlap or disposed to be adjacent to one another, the first embossed pattern of the first surface 102a and the second embossed pattern of the second surface 102b prevent the at least the first portion and the at least the second portion from nesting due to the patterns being offset from one another or because the patterns are not capable of nesting at all (square peg in a round hole). Thus, the substrate may include one or more air gaps 103 between the at least the first portion of the first surface 102a and the at least the second portion of the second surface 102b.

One measurement of nesting may be conducted by comparing the theoretical maximum thickness of the product to the actual thickness of the product. The theoretical maximum thickness of the product may be measured by measuring the thickness of a layer, multiplying that thickness by the number of layers. The actual measured thickness of the finished product will likely be less than the theoretical maximum thickness. The difference between the theoretical maximum thickness and the actual thickness provide a good indicator on how much nesting occurs between the layers. The closer the actual thickness is to the theoretical maximum thickness, means the product has a minimal amount of nesting. However, the greater the difference between the actual thickness and the theoretical maximum thickness equals to more nesting.

The anti-nesting properties of the first surface 102a and the second surface 102b promote and create more air gaps 103 between the plurality of layers due to the first embossing pattern and the second embossing pattern. If these specific embossing patterns did not exist or not crafted to be anti-nesting, few or no air gaps 103 would exist between the plurality of layers. Generally, the larger numbers and/or volume of air gaps between layers enhances insulative properties of the insulation product 100 whereas lower numbers and/or volume of air gaps between layers decreases the insulation properties of the insulation product 100. In other words, good insulators will (i) maximize the amount of air entrapped within a given volume, (ii) compartmentalize air into thousands of small pockets so as to interpret convective heat exchange, (iii) use minimal material to accomplish (i) and (ii) and because the material acts as a conduction pathway, (iv) be resistant to compression (e.g., typical vertical loads may be around 15-20 psi) as this lowers thickness, reduces the entrapped air, and increased density, which all increase thermal conductivity, (v) will rebound when compressed in order to gain back their insulation properties (e.g., after 25 hours of compression to 50%, the insulation product should have a 50% rebound (e.g., 1″ to 0.5″ for 24 hours to 0.75″ final thickness).

Table 1 compares various test products based on a number of characteristics such as whether the product included anti-nesting patterns, the test products loft, the product weight, and material type.

TABLE 1
Anti-nesting, Loft, and R-Values

| Test | | | Loft (10 | | |
|---|---|---|---|---|---|
| Product | Anti- | | layers, 0.03 | | R-Value |
| # | Nesting? | Weight (g) | lbs. load (in) | R-value | per inch |
| 1 | No | n/a | 0.165 | 0.667 | 4.04 |
| 2 | No | 4.8 | 0.150 | 0.620 | 4.13 |
| 3 | Yes | 4.69 | 0.205 | 0.928 | 4.53 |
| 4 | Yes | 4.81 | 0.405 | 1.655 | 4.09 |
| 5 | Yes | 5.55 | 0.535 | 2.017 | 3.77 |
| 6 | No | 4.77 | 0.130 | 0.587 | 4.51 |

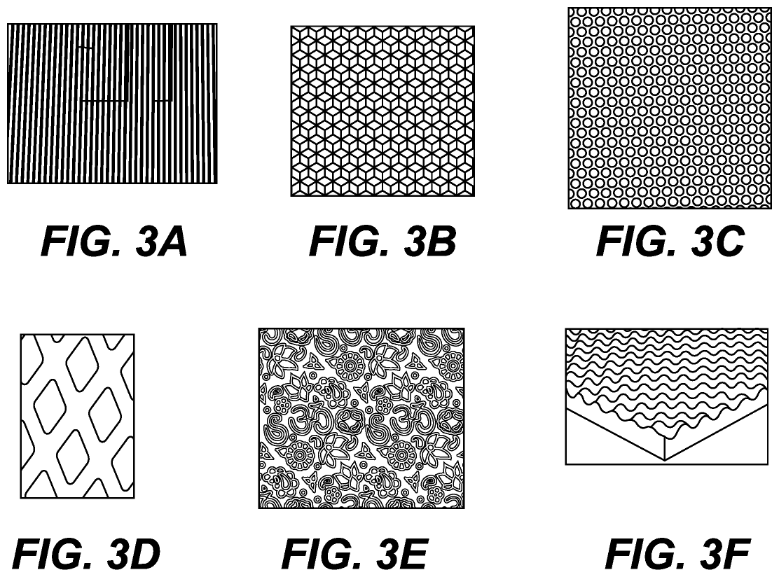

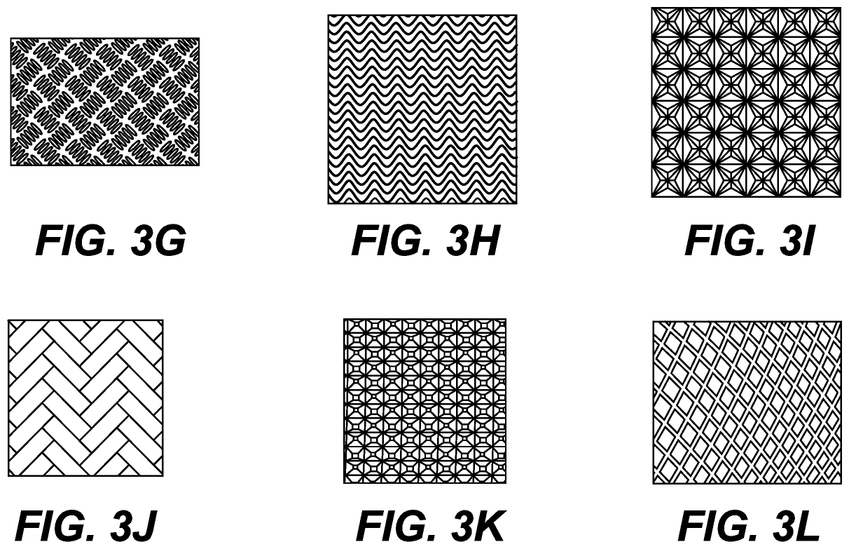

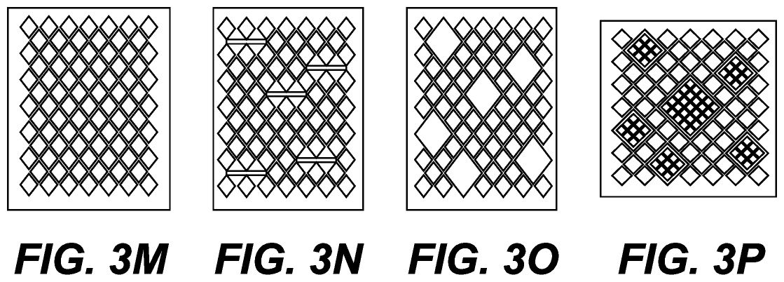

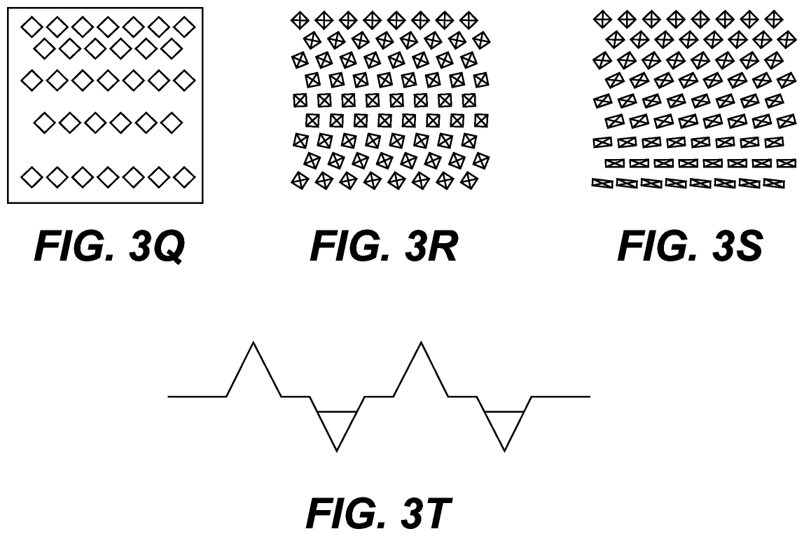

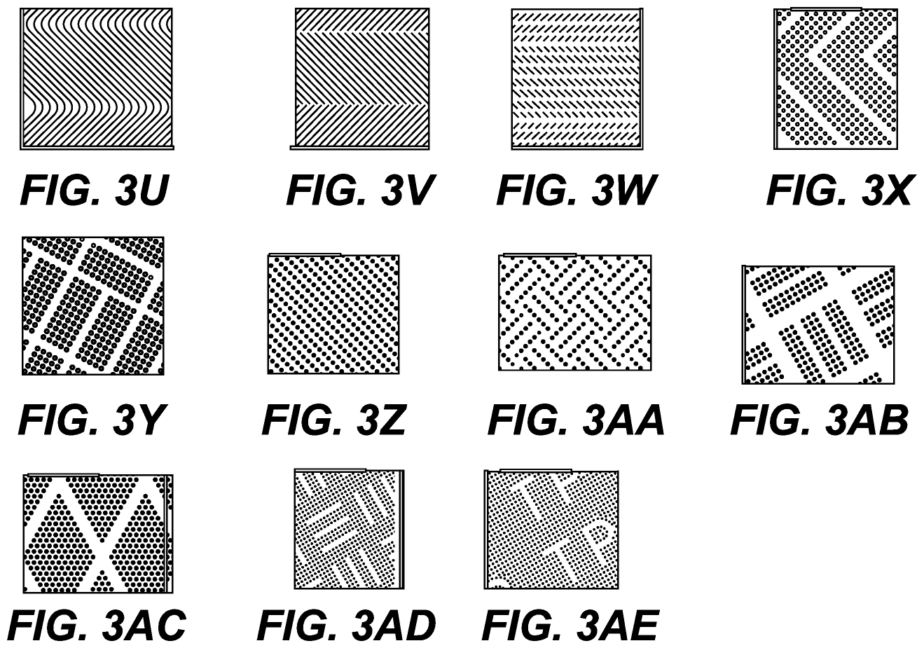

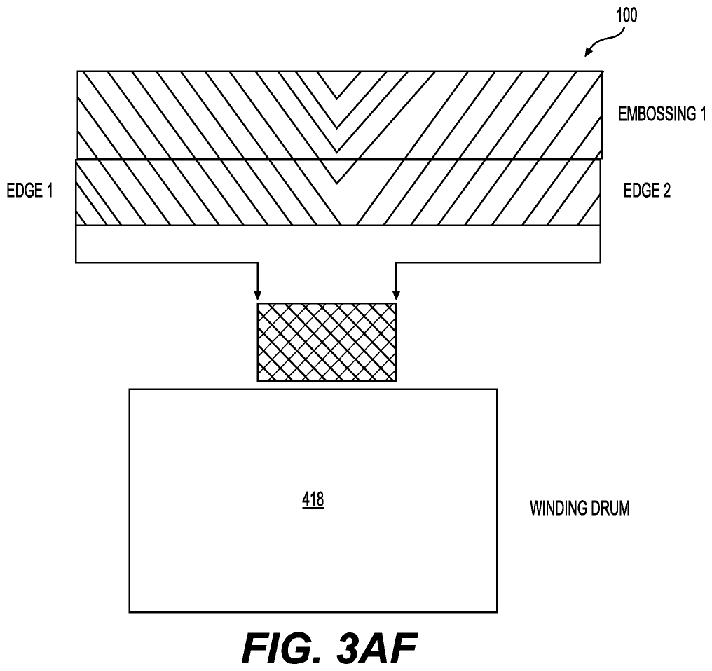

Test products numbers 1-6 may include tissue paper as the substrate. The issue paper may be tan or brown (kraft) color. Test product 1 may have a basis weight of 11.31 lbs and does not have any embossing or added anti-nesting properties. Test products 2-6 may have a basis weight of 12.5 lbs with a thickness of 0.0027 inches (in unwound state). Test products 2 and 6 do not have any embossing or added anti-nesting properties while test products 3-5 do. Specifically, test product 3 has an alternating diagonal line pattern shown in FIG. 3V (described below) as its embossing pattern. Test product 4 has a three-row dotted rectangle alternating pattern as shown in FIG. 3AB (described below) as its embossing pattern. Test product 5 has a corrugated structure rather than an embossing structure.

Table 1 shows that anti-nesting embossing patterns or corrugation generally have higher R-values for a product with 10 layers than those without anti-nesting embossing patterns or corrugation. In addition, Table 1 shows that not all patterns or corrugation equate to a higher R-value per inch of thickness of a product. For example, the corrugated structure (test product 5) had a high R-value of 2.017 but a lower R-value per inch of 3.77 compared to test product 3 with an alternating diagonal line pattern embossing which as an R-value of 0.928 and a R-value per inch of 3.53.

Table 2 compares the same test products based on their displacement, compression, and rebound when subjected to a force such as grocery items.

TABLE 2
Displacement, Compression, and Rebound

| | | | Rebound | |
|---|---|---|---|---|
| | Displacement | % | Height at 10 | |
| | (mm) at 5N | Compression | lbs. load for | % lost in |
| # | force | at 5N force | 24 hours (in) | thickness |
| 1 | 1.73 | 41% | n/a | n/a |
| 2 | 1.81 | 48% | 0.135 | 10% |
| 3 | 4.16 | 80% | 0.175 | 14.63% |
| 4 | 5.65 | 55% | 0.265 | 34.57% |
| 5 | 4.64 | 34% | 0.355 | 33.64% |
| 6 | 2.63 | 80% | 0.075 | 42.31% |

Table 2 show that using anti-nesting patterns or corrugation does not necessarily translate to better rebound (the ability for the test product to regain its shape after a compression force). As shown, test products 4 and 5 have generally poor % loss in thickness (above 30%). On the other hand, test product 3 has the second lowest percent loss (14.63%) in thickness after a 5-newton compression force compared to test product 2 with (10%). Thus, combining the results of Tables 1 and 3, test product 3 has the best R-value per inch of 3.53 and one of the highest % loss in thickness.

The substrate of the insulation product 100 may form a ring from a pad of the substrate. The pad may be of any size (e.g., 12″ by 36″). Once the ring is formed, it may be placed in a grocery bag (e.g., a paper grocery bag). The bag may have a corrugated pad on the bottom to prevent conduction while the ringed insulation product will insulate the sides of the bag that are normal to the ground. In some embodiments, the ringed insulation product is a rigid enough structure so that the grocery bag can be easily loaded with perishables without the insulation slouching over or otherwise impeding packing.

The substrate of insulation product 100 may have four ends and in some embodiments one or more fold lines 104a, 104b. However, in some embodiments the product will be generally flexible that fold lines will not be needed and not be included. Thus, the features described in this paragraph may apply to the embodiments without prior-formed fold lines. The first end and second ends distal to one another may show the exposed layers. The third and fourth ends distal to one another may be perpendicular or approximately perpendicular to the first and second ends. With the third end facing down (e.g., toward the flat ground), the insulation product may include a first fold line 104a positioned on an upper portion of the substrate and a second fold line 104b positioned on a lower portion of the substrate so that the substrate folds into a “C” shape with less pressure than a substrate would without the first and the second fold lines. The “C” shaped substrate may be combined with another “C” shaped substrate to form six sides of insulation for a shipping container or box. The first- and second-fold lines may be generated by folding the substrate at the two desired fold locations a predetermined number of times after the substrate is wound and bound. In some embodiments where fold lines are present, the fold lines may be created with ply bonds (i.e., the layer bonding process) to make a de facto crease line or lines.

The substrate may be one continuous layer and may include paper. The substrate may include paper. The substrate may be recyclable. The substrate may be wound to include 5-25 layers and may be 0.05 to 3.5 inches thick. The insulation product may thermally insulate a product wrapped in the insulation product (likely in a box) for 2 hours to 60 hours depending on the thickness and number of layers in the insulation product. In some embodiments, the substrate may include starch additives or other adhesive particles to help promote ply bonding. The starch additives or other adhesive particles may be activated (e.g., with water, heat, pressure, or other energy source).

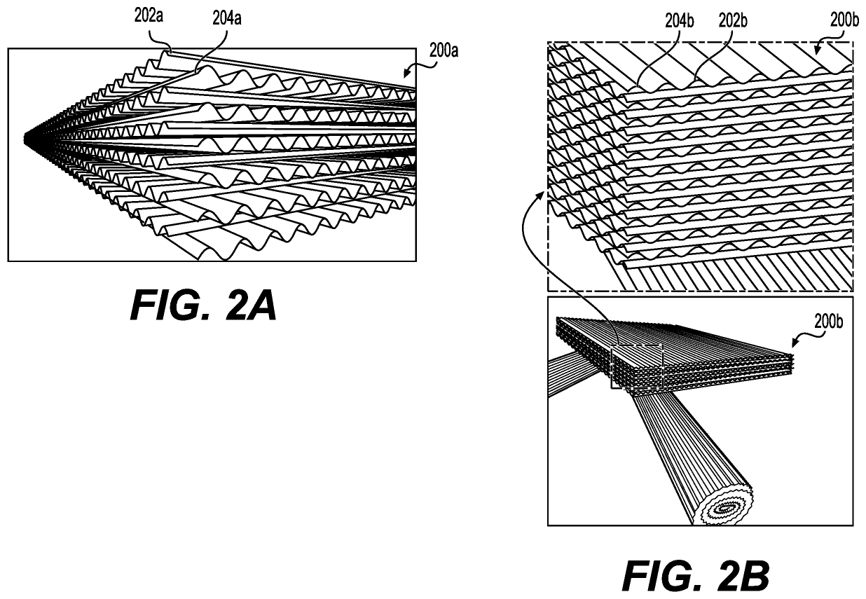

FIG. 2A is a perspective view of a model of another insulation product according to an exemplary embodiment. The insulation product 200a of FIG. 2A illustrates a first layer 202a having a first embossing pattern and a second layer 204b having a second embossing patterns. The first layer 202a may be formed from a first substrate and the second layer 204b may be formed from a second substrate so that the first and second substrate are alternatively layered on top of each other and do not nest due the embossing patterns and the layering, but instead promote airgaps between the layers. Six panels of the insulation product 200a may be combined to form an interior of a shipping container or a box. In other embodiments, the insulation product 200a could be made into a rectangular panel and used to cover three faces of a box.

FIG. 2B is a perspective view and an enlarged perspective view of a sample of an insulation product according to an exemplary embodiment. Insulation product 200b is an actual sample of the insulation product depicted in FIG. 2A. Similarly, insulation product 200b show alternating a first layer 202b with a second layer 204b so that the layers do not nest, but instead promote airgaps between the layers.

FIGS. 3A-3L are images of various embossing patterns suitable for the insulation product according to various exemplary embodiments. FIGS. 3M-3AF are diagrams of various embossing patterns suitable for the insulation product according to various exemplary embodiments.

FIG. 3A illustrates a corrugated pattern. FIG. 3B illustrates an isometric cubic pattern. FIG. 3C illustrates a bubble pattern. FIG. 3D illustrates a diamond pattern. FIG. 3E illustrates a custom artwork or abstract pattern. FIG. 3F illustrates a convoluted egg crate pattern. FIG. 3G illustrate an anti-slip pattern. FIG. 3H illustrates a wave pattern. FIG. 3I illustrates a first pyramidal pattern. FIG. 3J illustrates a herringbone pattern. FIG. 3K illustrates a second pyramidal pattern of an engraved roller that is split into equal squares, every other square has a pyramid that protrudes outward with the rest of the squares are the base of an equally sized pyramid that is recessed into the roll. The “peak to valley” distance may be around 0.075″ despite the higher durometer rubber not capturing much of the recessed portion of the pattern. FIG. 3L illustrates a waffle pattern of an engraved roller with a pattern depth that may be 0.035″. FIG. 3M illustrates the second pyramidal pattern. FIG. 3N illustrates the second pyramidal pattern with anti-nesting bars. FIG. 3O illustrates a variable sized pyramidal pattern. FIG. 3P illustrates a variable sized and density pyramidal pattern. FIG. 3Q illustrates variable spacing of a pyramidal pattern. FIG. 3R illustrates a pyramidal pattern with row rotation. FIG. 3S illustrates a pyramidal pattern with row rotation and skew. FIG. 3T is a side view of the second pyramidal pattern with the recessed portion partially filled in. FIG. 3U illustrates a wave pattern. FIG. 3V illustrates an alternating diagonal line pattern. FIG. 3W illustrates a dashed alternating diagonal line pattern. FIG. 3X illustrates a dotted arrow pattern. FIG. 3Y illustrates a first dotted rectangular row pattern. FIG. 3Z illustrates a dotted diagonal row pattern. FIG. 3AA illustrates a three-row dotted line alternating pattern. FIG. 3AB illustrates a three-row dotted rectangle alternating pattern. FIG. 3AC illustrates a dotted diamond pattern. FIG. 3AD illustrates a negative three-row dotted line alternating pattern. FIG. 3AE illustrates an example of a custom pattern with the letters “TP”. FIG. 3AF illustrates a mirror image pattern where a 45 degree diagonal patterns has two parts which are mirror images of each other about a centerline of the substrate. The first embossing pattern of the first surface 102a of insulation product 100 may include any one of these patterns illustrated in FIGS. 3A-3AF or variations thereof. The second embossing pattern of the second surface 102b of insulation product 100 may include a negative imprint of the first pattern or vice versa. However, the first and second embossing patterns are not limited to the patterns illustrated and described herein.

The machines and processes described herein were designed with the following process considerations: (1) focus on continuous process design with one machine direction to facilitate higher process speeds and lower capital expenditure; (2) minimize moving parts such as by limiting most moving parts to gears, conveyors, and unwind or rotatory driven parts; (3) minimize consumable and maximize recyclability by not using adhesives; (4) minimize change overs by using a master roll rather that many different initial rolls; (5) minimize capital expenditure by using one ply per roll or multiple plies per roll; and (6) minimize human touch since labor is expensive and substrate may be extremely delicate, especially if the substrate include tissue.

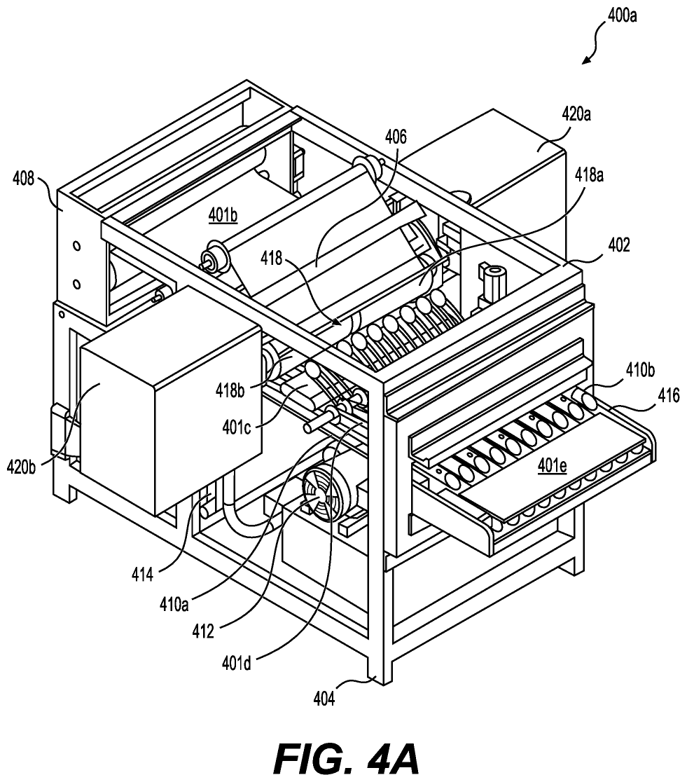

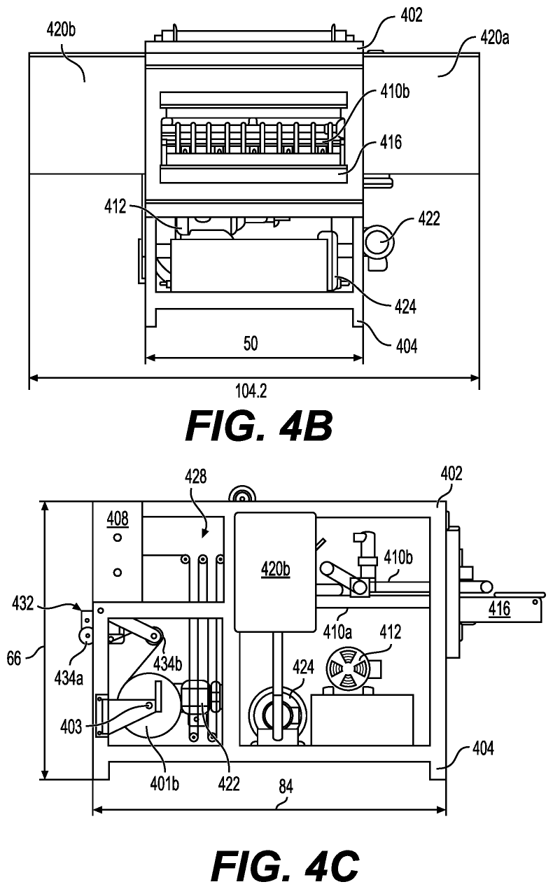

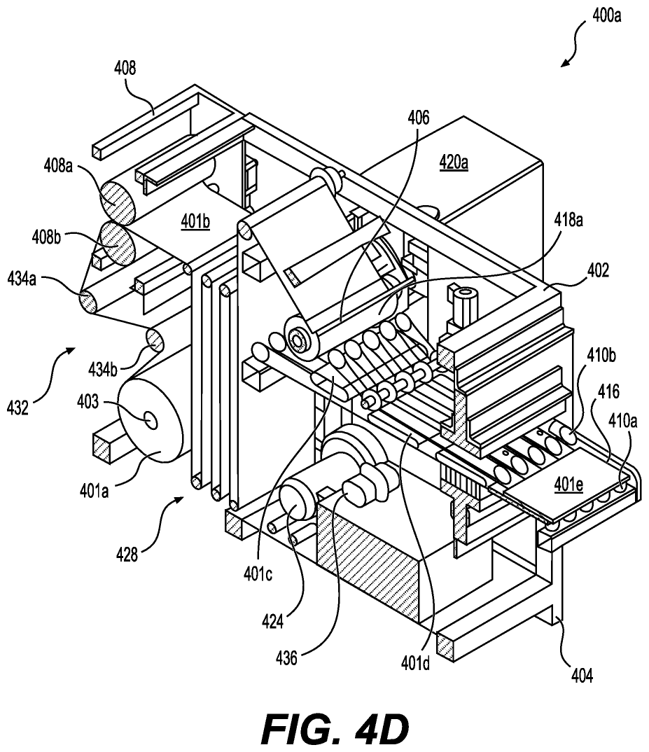

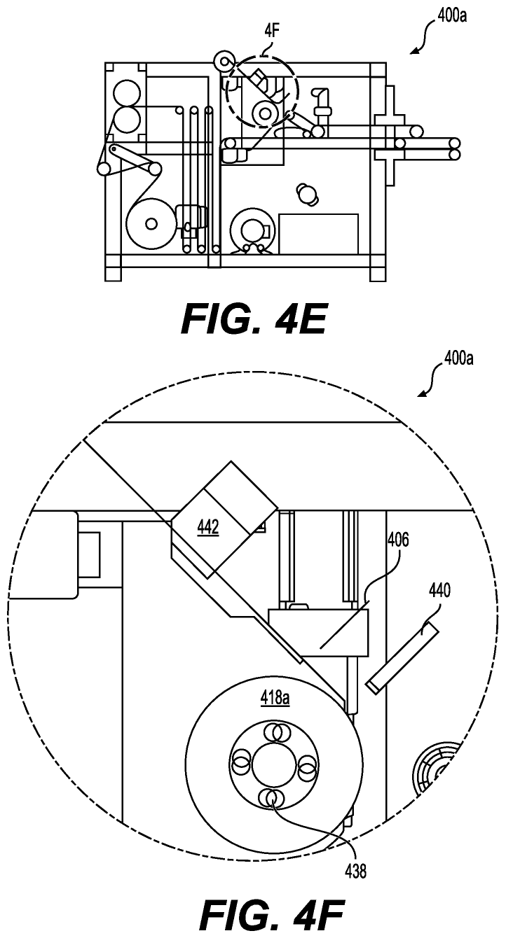

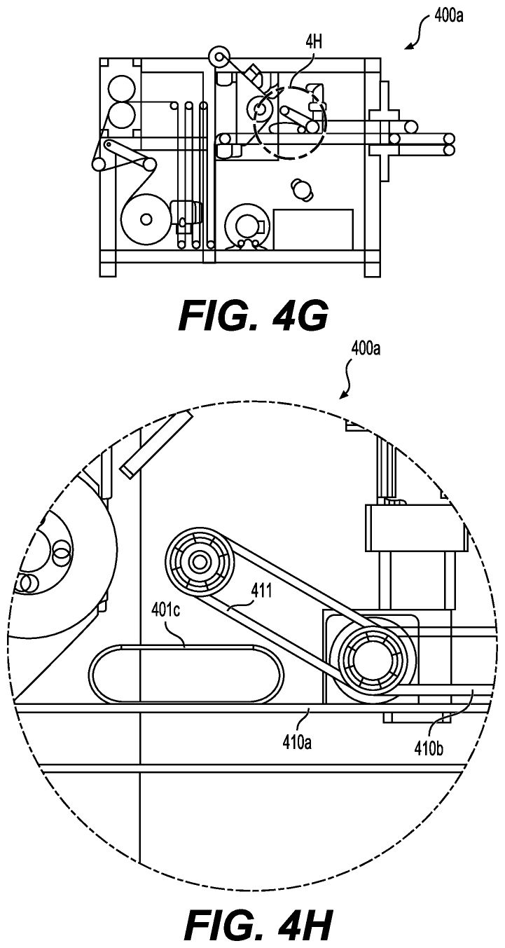

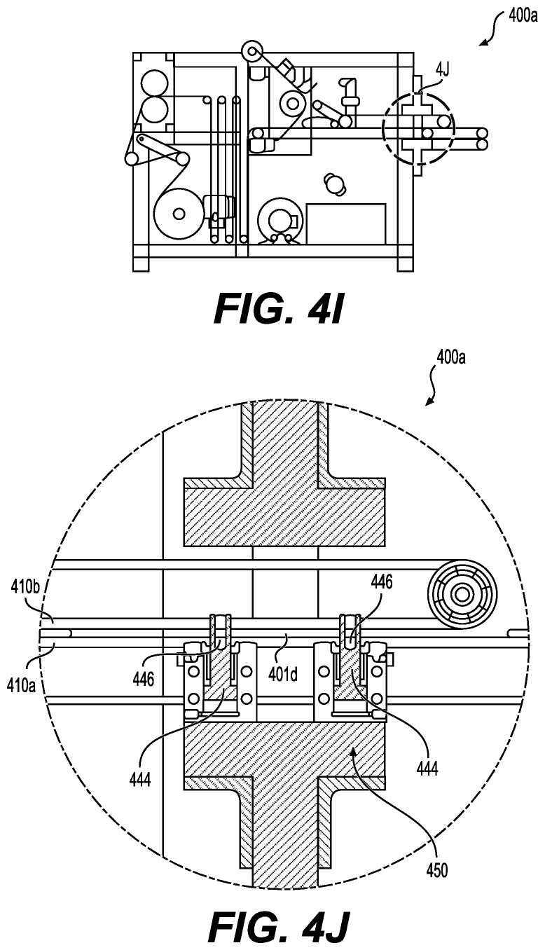

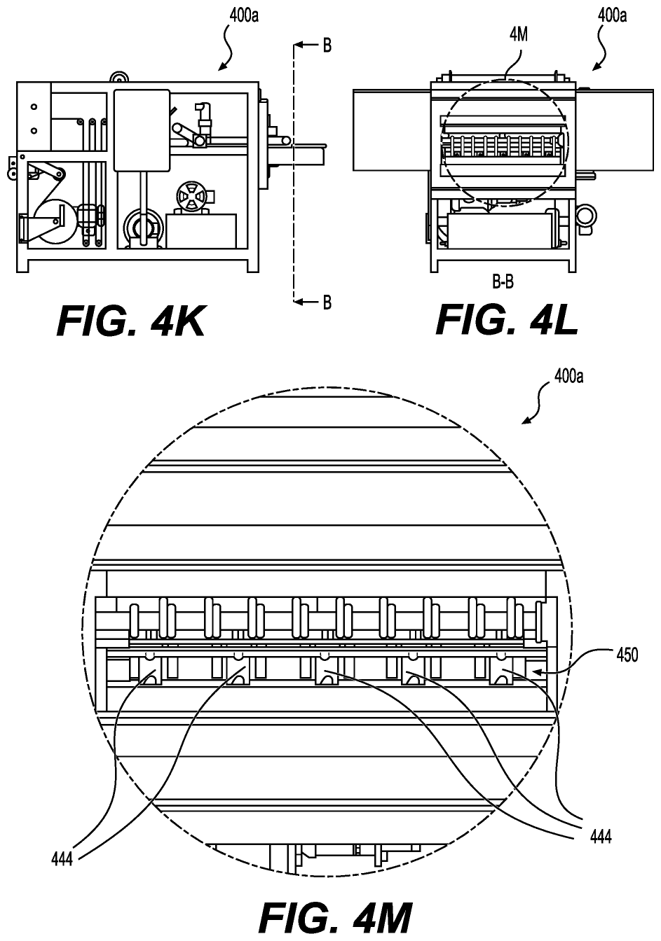

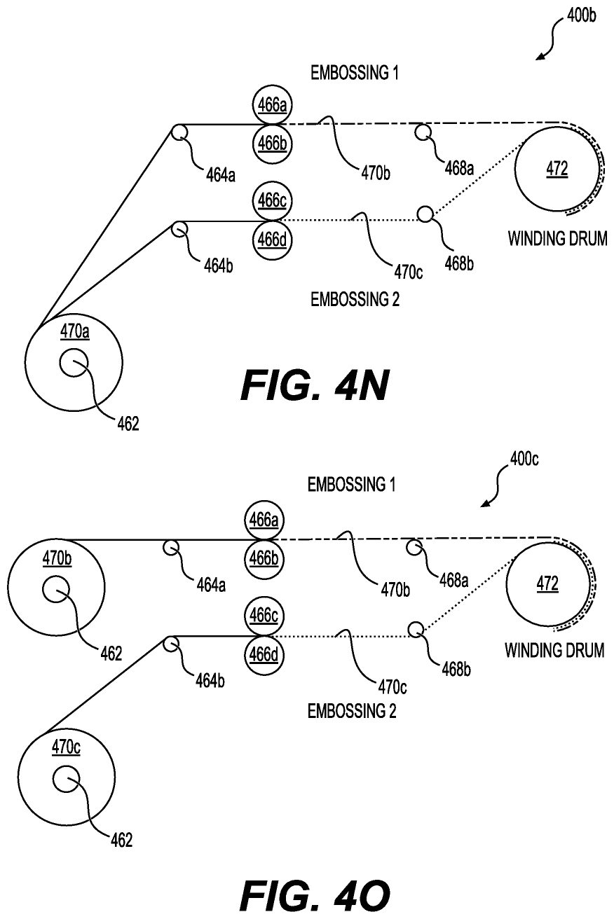

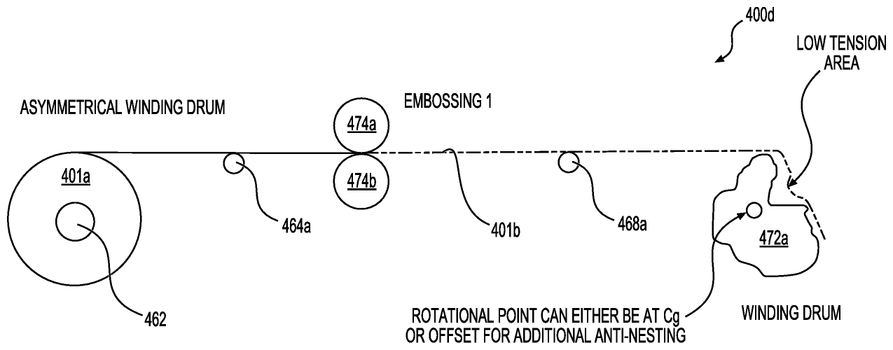

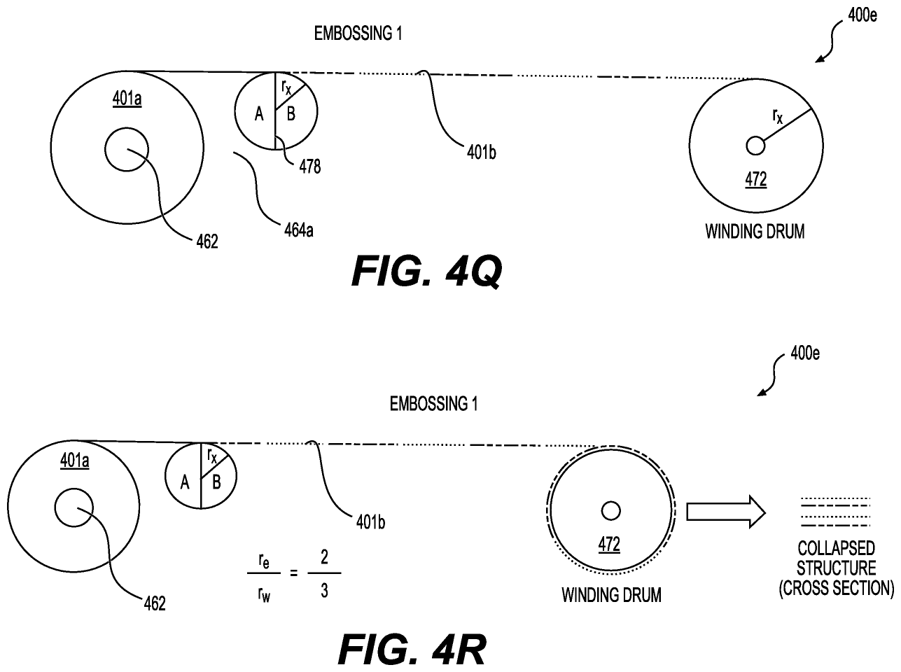

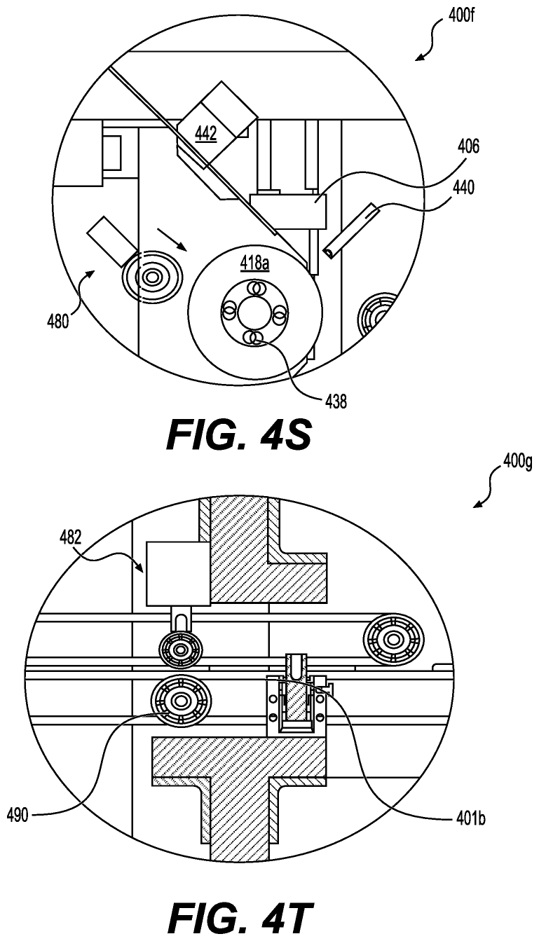

FIGS. 4A-4M are various views of a machine for making the insulation product 100 according to an exemplary embodiment.

As shown in FIGS. 4A-4D, the machine 400a may include a frame 402 upon which all other components of the machine 400a are attached directly or indirectly. The frame 402 may include legs 404 such as four legs 404. The frame 402 may be in the shape of a cuboid or rectangular cuboid.

As shown in FIGS. 4C and 4D, the machine 400a may also include an initial roller 403 that houses a roll of the substrate 401a having a first thickness. The first thickness may be 0.0001″ thick to 0.01″ thick (e.g., 0.0015″ thick to 0.0047″ thick). The initial roller 403 may be rotatable. In some embodiment the initial roller 403 may be connected to a motor 422 and a controller (not shown) that rotate the initial roller 403 to unwind or wind the roll of the substrate 401a. The machine 500 may also include other motors, drivers, or vacuums 436, 424, 412 to provide power, mechanized movement, or vacuum to various rollers or conveyor belts 410a, 410b of the machine 500.

As shown in FIGS. 4C and 4D, the machine 400a may also include a tension control system 432 that includes at least one tension roller such as at least two tension rollers 434a, 434b. The at least two tension rollers 434a, 434b are configured to unwind the roll of the substrate 401a at a first predetermined speed and align the substrate for embossing. The at least two tension rollers 434a, 434b may adjust laterally and/or vertically to adjust the tension in the substrate. In some embodiments the tension control system may include a tension controller that receives a tension measurement of the tension in the substrate from a tension sensor and automatically adjusts the at least two tension rollers 434a, 434b until the received tension measurement in the substrate from the tension sensor is within a predetermined threshold of a set tension.

The machine 400a may also include an embossing (or corrugating) system 408, as shown in FIGS. 4A, 4C, and 4D. The embossing system 408 may be configured to emboss a first surface of the substrate 401a and a second surface of the substrate 401a that is opposite the first surface. Alternatively, only the first surface of the substrate 401a or only the second surface of the substrate 401a may be embossed. To accomplish the embossing, the embossing system may include a first embossing roller 408a and a second embossing roller 408b. The first embossing roller 408a may include a first negative or positive imprint of a first embossing pattern desired to be embossed on the first surface of the substrate 401a. Similarly, the second embossing roller 408b may include a second negative or positive imprint of a second embossing pattern desired to be embossed on the first surface of the substrate 401a. The second negative or positive imprint may be a negative imprint of the first negative or positive imprint. Alternatively, the first embossing roller 408a or the second embossing roller 408b may not contain any embossing pattern as described more below. In some embodiments, the embossing system 408 may instead be a corrugating system with first and second embossing rollers 408a, 408b being first and second corrugating rollers. Each of the first and second corrugating rollers include teeth suitable to form a corrugated substrate.

The first embossing roller 408a and the second embossing roller 408b may apply a first predetermined pressure (e.g., 500 to 1500 PSI) to the respective first surface and the second surface of the substrate to emboss the substrate by spacing the first embossing roller 408a and the second embossing roller 408b a first predetermined distance form one another. The first predetermined pressure will be adjustable via the machine's controller. For example, various process (e.g., temperature of a substrate of machine above a predetermined temperature threshold) and environmental conditions (e.g., humidity above a predetermined humidity threshold) measured by one or more sensors (e.g., thermocouple or humidity sensor) result in the machine's controller issuing an alarm or automatically adjusting (e.g., lowering) the first predetermined pressure.

In the embossing system 408, the first embossing roller 408a and the second embossing roller 408b may be made of or include steel or ebonite. These rollers may be a perfect mated pair, which allows for a crisp emboss pattern.

In the embossing system 408, either the first embossing roller 408a or the second embossing roller 408b may include a pattern engraved on it. The other non-engraved roller (either 408a or 408b) may be a smooth elastomeric rubber roll or a paper role. As the two rollers are press together and driven, the elastomeric nature of the rubber or properties of the paper roller allows the surface of the non-engraved roller to conform and move into the recesses on the opposing roller that is engraved. The rubber or paper roller moves the substrate along with it thereby embossing the substrate. It is important to select the correct durometer rubber for the roller based on the embossing pattern and the substrate. If paper is used, it must be prepared by rolling the paper against the engraved roller for an extended period of time. Once prepared, the paper roller effectively, takes the shape of a mated roll with a perfect negative imprint of the engraved roll.

In some embodiments, the engraved roller corresponds to roller 408b (the bottom one) and the rubber or paper roller corresponds to roller 408a (the top one). Generally, static electricity will be generated through the embossing process and result in the substrate 401b being statically charge clinging to the rubber or paper rubber. By using the engraved roller as the bottom roller 408b and the rubber or paper roller as the upper roller 408a, the static forces will have to work against gravity to pull the substrate toward the upper roller 408a. With this set up, the flow of the substrate is not impeded due to static electricity.

The at least two tension rollers 434a, 434b may feed the substrate 401a to the first embossing roller 408a and the second embossing roller 408b that rotate to emboss the first pattern on the first surface of the substrate 401a and the second pattern on the second surface of the substrate 401a to create an embossed substrate 401b at the first predetermined speed (e.g., 0.01 feet per minute to 700 feet per minute such as 300 feet per minute). The first embossing roller 408a and the second embossing roller 408b may emboss their respective surfaces of the substrate at the same time or substantially the same time.

As shown in FIGS. 4C and 4D, the machine 400a may also include a set of accumulation rollers 428. The set of accumulation rollers 428 may include three or more rollers such six or seven rollers. The set of accumulation rollers 428 are configured to transition the embossed substrate 401b from a first predetermined speed to a second predetermined speed that is different than the first predetermined speed. The set of accumulation rollers include one or more lower rollers and two or more upper rollers. In some embodiments, the lower rollers move vertically up and down. When the lower rollers are in the up position, the substrate travels a relatively short distance to reach the drum 418. Because the embossing process is typically faster than the winding process by the drum 418, the a machine controller moves the lower rollers towards the bottom of the machine thereby increasing the distance the substrate travels to move through the set of accumulation rollers to the drum 418. The machine controller directs the lower rollers to move vertically up when the winding process starts and draws in the substrate.

It's important to note that when the set of accumulation rollers is complete filled with the lower rollers extended to the lowest position, the machine would have to stop. In some embodiments, the set of accumulation rollers never fills up due to design specifications.

The machine 400a may also include a drum 418 as shown in FIGS. 4A, 4D, 4E, and 4F. The drum 418 may be configured to wind the embossed substrate 401b a predetermined number of times at a second predetermined speed to create a wound and embossed substrate 401c including a plurality of layers. Once the drum 418 winds the embossed substrate 401b a predetermined number of times, the drum is retracted away from the embossed substrate causing the wound and embossed substrate 401c to release from the drum 418 and fall on a lower conveyor belt 410a described below and shown in FIGS. 4A and 4D.

In some embodiments, the drum 418 includes a first portion 418a including one or more first connectors 438 and a second portion 418b including one or more second connectors (not shown but mated pair to the one or more first connectors). The first connectors 438 of the first portion 418a are configured to connect to and potentially lock with the second connectors of the second portion 418b. The first portion 418a of the drum 418 and the second portion 418b of the drum 418 are configured to separate and retract away each other and the embossed substrate causing the wound and embossed substrate to release from the drum 418 and fall on the lower conveyor belt 410a described below and shown in FIGS. 4A and 4D.

In some embodiments, the machine 400a may include one or more lowering arms (not shown) to assist the lowering of the wound and embossed substrate 401c to the lower conveyor belt 410a. The one or more lowering arms grab or catch the wound and embossed substrate 401c once released from the drum 418 and lower the wound and embossed substrate 401c substrate to the lower conveyor belt 410a. The controlled lowering of the wound and embossed substrate 401c would help prevent the wound and embossed substrate 401c from unraveling.

In some embodiments, the drum 418 may include perforation holes that are fluidly connected to a vacuum (e.g., positioned within the drum 418 or positioned on the frame 402 and connected to one end of the drum via a hose or pipe). The vacuum may cause a portion of the embossed substrate to temporarily adhere to an outer surface of the drum 418 so that the embossed substrate efficiently wraps around the drum 418 during the winding process. In other embodiments, the first portion 418a of the drum 418 may include first perforation holes fluidly connected to a first vacuum. The second portion 418b of the drum 418 may include second perforation holes fluidly connected to the same first vacuum or a second vacuum. The first and second vacuum are not shown but may be respectively within the first portion 418a and the second portion 418b of the drum 418. Alternatively, the first and second vacuums may be one and the same but with different piping or hose connecting to the one vacuum to the first and second portions of the drum 418a, 418b. Regardless of whether two separate vacuums or one vacuum, it may cause a portion of the embossed substrate to temporarily adhere to an outer surface of the first portion 418a and the second portion 418b of drum 418 so that the embossed substrate efficiently wraps around the drum 418 during the winding process. In some embodiments, an air system (e.g., the one or more vacuums operating in reverse) may send a burst of air (e.g., compressed air) through the perforation holes in the drum 418 just before the portions 418a, 418b of the drum 418 pull apart in order to prevent the wound and embossed substrate 410c from sticking to the drum 418.

In some embodiments, the machine 400a may include a static beam 440 as shown in FIG. 4F that may induce a localized polarization across the embossed substrate 401b. The static beam 440 may impart a first electric charge (e.g., positive charge) on the first surface of the substrate so that the first surface (e.g., the inner surface when wound) of the embossed substrate 401b is attracted to the drum during the winding process. For example, the static beam 440 may be positively charged and may attract the negative charges of the embossed substrate 401b toward the second surface of the substrate (e.g., the outer surface when wound) so that the positive charges of the embossed substrate 401b concentrate toward the first surface.

Similarly, in some embodiments, the drum 418 (or first portion 418a and second portion 418b) may be imparted (e.g., using one or more static beams not shown) with a second electric charge (e.g., negative charge) that is opposite the first electric charge. By imparting opposite charges on the first surface of the embossed substrate and the outer surface of the drum 418, the embossed substrate 401b may temporarily adhere to the outer surface of the drum 418.

The machine 400a may also include a guillotine 406 as shown in FIGS. 4A, 4D, and 4F. The guillotine 406 may separate and cut the embossed substrate from the wound and embossed substrate before the drum 418 retracts (or separates and retracts) and releases the wound and embossed substrate on to the lower conveyor belt 410a.

The machine 400a may also include a clamp 442 (shown in FIG. 4F) or nip rollers configured to prevent the embossed substrate 401b from falling backwards after the guillotine 406 performs its cut.

The machine 400a may also include a lower conveyor belt 410a and an upper conveyor belt 410b as shown in FIGS. 4A, 4C, 4D, and 4H. The lower conveyor belt 410a is spaced a predetermined distance apart from the upper conveyor belt 410b. The predetermined distance that the lower and upper conveyor belts 410a, 410b are spaced apart may be adjusted manually or automatically based on a desired thickness of the end product 401d.

The upper conveyor belt 410b may include an angled portion 411 as shown in FIG. 4H. The angled portion 411 may receive the wound and embossed substrate 401c from the lower conveyor belt 410a. Once received, the angled portion 411 may gradually compress or collapse the wound and embossed substrate 401c by forcing the wound and embossed substrate 401c through an opening that gradually decreases in size in proportion of the angle of the angled portion 411. In other words, the lower conveyor belt 410a and the upper conveyor best 410b create a collapsed substrate 401d.

The lower conveyor belt 410a and the upper conveyor best 410b are configured to transport the collapsed substrate 401d to a bonding system 450 illustrated in FIGS. 4J and 4M and described below

As shown in FIGS. 4J and 4M, the machine 400a may also include a bonding system 450. The bonding system 450 may include one or more actuators 444 attached to one or more pins 446. The one or more actuators 444 are configured to apply a predetermined amount of pressure to the collapsed substrate 401d via the one or more pins against one or more anvils (e.g., one or more plates) to form one or more bonds between the plurality of layers of the collapsed substrate 401d. The one or more pins may be positioned above upper conveyor belt 410b and the one or more anvils or plates may be positioned below lower conveyor belt 410a, where the machine 400a moves the two together, squeezing the collapsed substrate 401d in the middle and forming a ply bond. In some embodiments, the one or more pins may be positioned below the lower conveyor belt 410a and the one or more anvils or plates may be positioned above upper conveyor belt 410b. In other embodiments, either the one or more pins or the one or more anvils or plates may be static while the other moves. In some embodiments, raised may be used and result in better ply bonds than non-raised anvils.

The machine illustrated in FIGS. 4A-4M may be able to produce an insulation product having dimensions of 6-12 inches by 12-60 inches (e.g., 12 inches by 36 inches) and produce it at a rate of 300 feet per minute having up to 30 layers.

FIG. 4N is schematic diagram of another machine 400b for making the insulation product 100 according to an exemplary embodiment. Machine 400b may many of the same or similar components as machine 400a, except that machine 400b includes separate tension and embossing systems for two different piles or layers of one initial roll of a substrate 470a In FIG. 4N, a substrate having two layers or plies is placed on an initial roller 462. Each layer or ply of the substrate 470a is split between two different tension systems. The first tension system may include at least one tension roller 464a and the second tension system may include at least one tension roller 464b. Each layer of the substrate 470a is separately embossed with different pairs of embossing rollers. The first pair of embossing rollers 466a, 466b may create a first embossed layer 470b. The second pair of embossing rollers 466a, 466b may create a second embossed layer 470c. Each layer then moves past one or more accumulation or guide rollers 468a, 468b while the drum 472 winds the first embossed layer 470b and the embossed layer 470c. In some embodiments, one layer is not embossed and the corresponding embossing rollers may be omitted. In this case, the non-embossed layer may be flat and create a slip sheet effect to prevent layer son either side of it form nesting.

Although FIG. 4N illustrates two layers or plys, more than two (e.g., 3, 4, 5, 6, 7, 9, 10) layers or plys are envisioned.

FIG. 4O is schematic diagram of another machine 400c for making the insulation product 100 according to another exemplary embodiment. Machine 400c is similar to machine 400b, except that machine 400c uses two separate initial rollers 462 holding two rolls of the substrate 470b, 470c instead one substrate roll with two layers. Each substrate roll 470b, 470c supplies a layer or ply for separate embossing. In some embodiments, one layer is not embossed and the corresponding embossing rollers may be omitted. In this case, the non-embossed layer may be flat and create a slip sheet effect to prevent layer son either side of it form nesting.

Although FIG. 4O illustrates two initial rollers 462, more than two initial rollers may be used to provide more than two layers or plys (e.g., 3, 4, 5, 6, 7, 9, 10 layers).

FIG. 4P is a schematic diagram of another machine 400d for making the insulation product 100 according to another exemplary embodiment. Machine 400d may be similar to machine 400a except that machine 400d includes a non-symmetrical drum 472a. The non-symmetrical drum 472a may be used to create areas of different tension on the wound substrate. These areas of different tensions may prevent nesting and once the layers are attached (e.g., ply bonded) the anti-nesting areas will be held in place. Machine 400d may include an initial roller 462 holding a roll of a substrate 401a, one or more tension rollers 464a, a pair of embossing rollers 474a, 474b to create an embossed substrate 401b, one or more accumulation or guide rollers 468a, and the drum 472a. In some embodiments, the rotational point of the drum 472a may be at center (Cg) or offset for additional anti-nesting attributes (e.g., similar non-uniform portions of the wound substrate).

FIGS. 4Q and 4R illustrate machine 400e making the insulation product 100 according to another exemplary embodiment. Machine 400e is similar to machine 400a, except that at least one embossing roller 478 is configured to place two different patterns onto one surface of the substrate. If the right ratio of radio is selected between the at least one embossing roller 478 and the drum 478 (e.g., radius of embossing roller (rₑ) to radius of the drum (r_{w}) of 2:3) then the resulting collapsed wound structure will have alternative patterned layers. In some embodiments one pattern could be flat (e.g., no embossing) to create a slip sheet effect as described above. The machine 400e may include at least an initial roller 462 holding a rolled substrate 401a, at least one embossing roller 478 capable of imparting two embossing patterns (or one embossing pattern and no pattern), and a drum 472.

FIG. 4S is a schematic diagram of a bonding system according to an exemplary embodiment. As illustrated in FIG. 4S, machine 400f may be similar to the machine 400a described above, except that machine 400f may include a bonding system 480 that is configured to attach (e.g., using ply bonding force) each layer another layers or attach every few layers of the substrate as the substrate is wound around the drum 418. This bonding system 480 may take the place of bonding system 450 described above. This would result in stronger bonds rather than trying to bond the entire collapsed substrate 401d. The bonding system 480 may include a knurled ply bonding wheel that may retract inwards once the embossed substrate 401b is on the drum 418. The smooth drum 418 may serve as the anvil for the knurled bonding wheel to promote ply bonding between the layers of the substrate.

FIG. 4T is a schematic diagram of another bonding system according to an exemplary embodiment. As illustrated in FIG. 4T, machine 400g may be similar to the machine 400a described above, except that machine 400g may include a bonding system 482 (which may be in place of bonding system 450) that is configured to attach (e.g., using ply bonding force) the layers of the substrate to each other using a knurled ply bonding wheel and a smooth anvil 490. The benefits of bonding system 482 is that it may provide continuous ply bonding throughout the width of the collapsed substrate 401d. Typically, ply bonds (e.g., pressure bonds) are relatively week if they are single points because torsion through the collapsed substrate 401d may result in pre-mature failure of the ply bonds. However, continuous ply bonds provided by bonding system 482 are less susceptible to being broken from torsional stress.

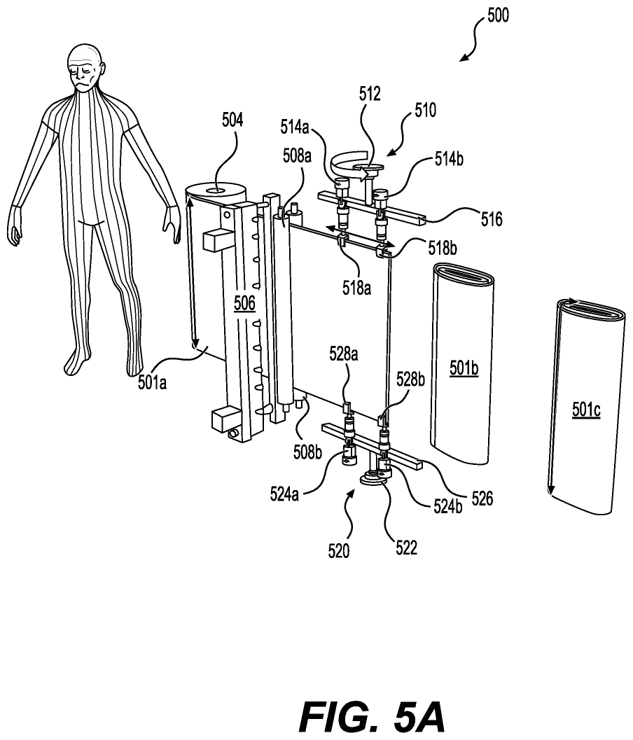

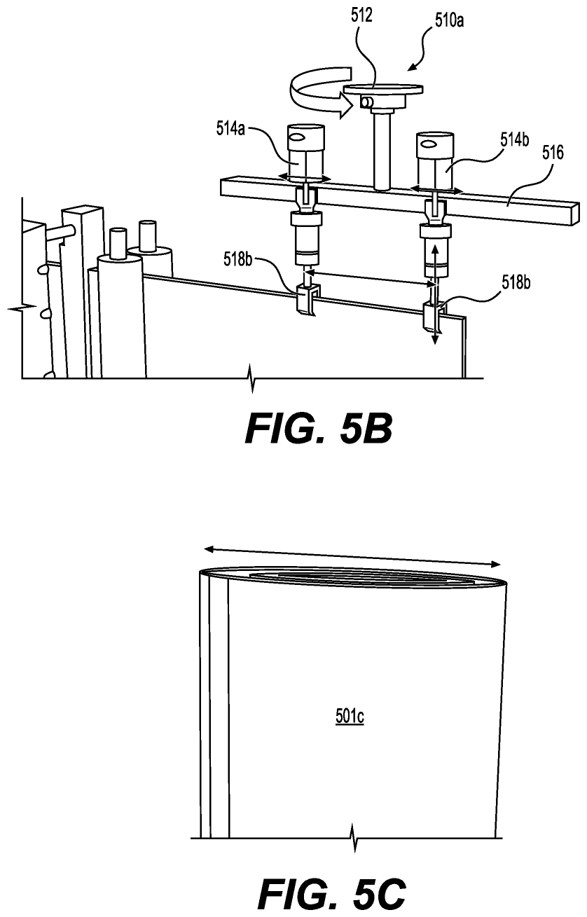

FIGS. 5A-5C are various view of another machine for making the insulation product 100 according to an exemplary embodiment.

As shown in FIG. 5A, the machine 500 may include an initial roller 504 that houses a roll of a substrate 501a. The roll of the substrate may have been previously embossed through a separate process. Alternatively, the roll of the substrate 501a may not be previous embossed and may be fed to a pair of embossing rollers similar to the first and second embossing rollers 408a, 408b of FIG. 4D. As described above, the first pattern of the substrate 501a formed from the pair of embossing rollers are configured to prevent nesting between a first surface and the second surface when wound to overlap or disposed to be adjacent to one another.

Also shown in FIG. 5A, the machine 500 may include a guillotine 506 for separating and cutting the embossed substrate from the wound and embossed substrate 501b.

As shown in FIGS. 5A and 5B, the machine 500 may include a first orbital gripper 510 that may include a first spacer 516, a first driver 512 connected to the first spacer 516, and a pair of first retractable grippers 514a, 514b adjustably connected to the first spacer 516. The pair of first retractable grippers 514a, 514b are spaced apart by a first predetermined distance (which corresponds to the width of the end product—e.g. a 12″ by 36″ product would mean the pair of first retractable grippers 514a, 514b are spaced apart by 12″) using the first spacer 516 with the first driver 512 disposed halfway between the pair of first retractable grippers 514a, 514b. The first retractable grippers 514a, 514b may each comprise a first adjustable clamp 518a, 518b configured to grip a first end of the embossed substrate 501b or a second end of the embossed substrate 501b that is opposite the first end. The first adjustable clamps 518a, 518b may be rubberized.

Similarly, the machine 500 may include a second orbital gripper 520 that may include a second spacer 526, a second driver 522 connected to the second spacer 526, and a pair of second retractable grippers 524a, 524b adjustably connected to the second spacer 526. The pair of first retractable grippers 524a, 524b are spaced apart by a second predetermined distance using the second spacer 526 with the second driver 522 disposed halfway between the pair of second retractable grippers 524a, 524b. The second retractable grippers 524a, 514b may each include a second adjustable clamp 528a, 528b configured to grip a first end, or a second end distal to the first end, of the embossed substrate 501b. The second adjustable clamps 528a, 528b may be rubberized.

The first orbital gripper 510 and the second orbital gripper 520 may wind the embossed substrate to create a wound and embossed substrate 501b including a plurality of layers by simultaneously rotating the first driver 512 and the second driver 522. While the winding process may be manual, a motor and associated controller may wind the first orbital gripper 510 and the second orbital gripper 520. The width of the wound and embossed substrate 501b may be changed by adjusting the spacing between the pair of first retractable grippers 514a and 514b along the first spacer 516 when detached from the embossed substrate and adjusting the spacing between the pair of second retractable grippers 524a and 524b along the second spacer 526 when detached form the embossed substrate. For example, an operator may loosed a clamp and slide the first retractable grippers 514a, 514b along the first spacer 516. Alternatively if the first spacer 516 was a rack and the first retractable grippers 514a, 514b were pinons, they could be turned via a small motor and moved along 516 automatically via a controller.

Additionally, the machine 500 may include a first nip roller 508a and a second nip roller 508b configured to guide the embossed substrate from the initial roller 504 while the first orbital gripper 510 and the second orbital gripper 520 wind the embossed substrate. Although FIG. 5A illustrate the first nip roller 508a and the second nip roller 508b between the guillotine 506 and the first and second orbital grippers 510, 520, the first nip roller 508a and the second nip roller 508b may be between the initial roller 504 and the guillotine 506. Put another way, the first nip roller 508a and a second nip roller 508b may hold the embossed substrate upstream of the guillotine so that the embossed substrate does not fall back.

In some embodiments, first and second nip rollers 508a, 508b may also serve as the pair of embossing rollers.

Although not shown, the machine 500 may include a bonding system similar to the bonding system 450 shown in FIGS. 4J and 4M and described above. The bonding system may create a bound substrate 501c as shown in FIG. 5C.

The machine illustrated in FIGS. 5A-5C may be able to produce an insulation product having dimensions of 6-12 inches by 12-60 inches (e.g., 12 inches by 36 inches) and produce it at a rate of 300 feet per minute having up to 30 layers.

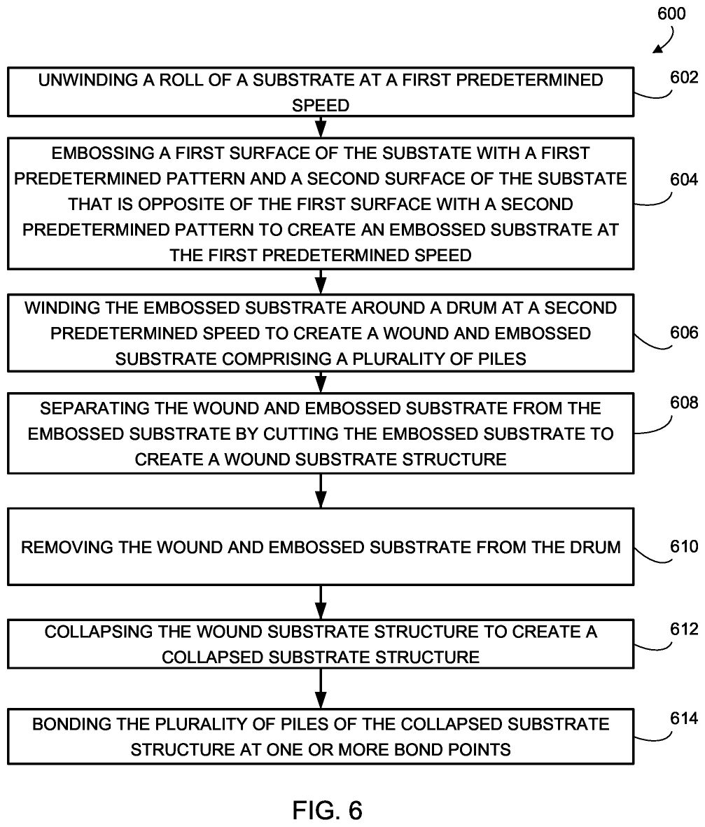

FIG. 6 is a flowchart of a method for making an insulation product according to an exemplary embodiment. The method 600 may include the one or more of the following steps referred to as blocks. This method may be used in conjunction with FIGS. 4A-M to provide visual context for some of the steps of the method.

In block 602, the method 600 may include unwinding a roll of a substrate at a first predetermined speed. The roll of the substrate 401a may be positioned on a rotatable initial roller 403 and unwound form the initial roller 403.

In block 604, the method 600 may include embossing a first surface of the substrate 401a with a first predetermined pattern and a second surface of the substrate 401b that is opposite of the first surface with a second predetermined pattern to create an embossed substrate 401b at the first predetermined speed. Embossing the first surface and the second surface may occur simultaneously or near simultaneously. The first surface and the second surface may be respectively embossed by a first embossing roller 408a that may include a first mirror image of the first predetermined pattern and a second embossing roller 408b that may include a second mirror image of the second predetermined pattern. The first pattern formed from the first embossing roller and the second pattern formed from the second embossing roller may be configured to prevent nesting between the first surface and the second surface when wound to overlap or disposed to be adjacent to one another.

In block 606, the method 600 may include winding the embossed substrate around a drum 418 at a second predetermined speed to create a wound and embossed substrate 401c comprising a plurality of layers. The drum 418 may be a rotatable drum 418.

In block 608, the method 600 may include separating the wound and embossed substrate 401c from the embossed substrate by cutting the embossed substrate to create a wound substrate structure 401c. The wound and embossed substrate may be separated from the embossed substrate by a guillotine 406.

In block 610, the method 600 may include removing the wound and embossed substrate 401c from the drum 418. The wound and embossed substrate may be removed from the rotatable drum 418 by retracting a first portion 418a of the rotatable drum 418 a first predetermined distance from a second portion 418b of the rotatable drum 418.

In block 612, the method 600 may include collapsing the wound substrate structure 401c to create a collapsed substrate structure 401d. The wound substrate structure 401c may be collapsed by a first (lower) conveyor belt 410a and a second (upper) conveyor belt 410b spaced a predetermined distance apart. The wound substrate structure may be gradually collapsed between an angled portion of the second conveyor belt 410b and the first conveyor belt 410a.

In block 614, the method 600 may include bonding the plurality of layers of the collapsed substrate structure 401d at one or more bond points. The bonding may be accomplished by applying a predetermined amount of pressure to the collapsed substrate structure 401d at one or more bond points to form one or more bonds between the plurality of layers. The plurality of layers may be bound by controlling one or more actuators 444 attached to one or more pins 446 to apply a predetermined amount of pressure to the plurality of layers of the collapsed substrate structure via the one or more pins 446 against one or more anvils or plates (not shown) to form one or more bonds between the plurality of layers. The predetermined amount of pressure may applied at the one or more bond points by moving one or more actuators 444 attached to one or more pins 446 such that the one or more actuators 444 apply pressure against one or more anvils or plates via the one or more pins 446 with the plurality of layers disposed between the one or more pins and the one or more anvils or plates.

In some embodiments, the method 600 may include transitioning the embossed substrate from the first predetermined speed to the second predetermined speed using a set of accumulation rollers 428, wherein the first predetermined speed and the second predetermined speed are different.

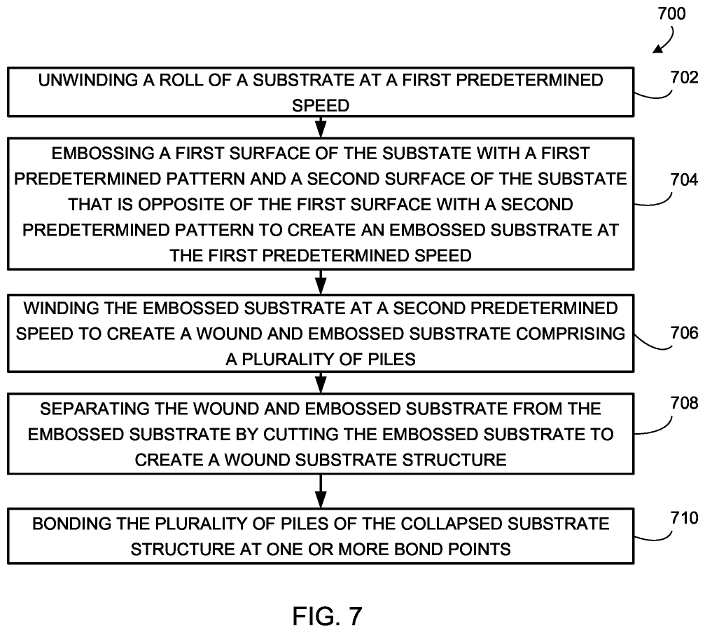

FIG. 7 is a flowchart of a method for making an insulation product according to another exemplary embodiment. The method 700 may include the one or more of the following steps referred to as blocks.

In block 702, the method 700 may include unwinding a roll of a substrate 501a at a first predetermined speed. The roll of the substrate 501a may be positioned on a rotatable initial roller 504.

In block 704, the method 700 may include embossing a first surface of the substrate with a first predetermined pattern and a second surface of the substrate that is opposite of the first surface with a second predetermined pattern to create an embossed substrate at the first predetermined speed. Embossing the first surface and the second surface may occur simultaneously or nearly simultaneously. The first surface and the second surface may be respectively embossed by a first embossing roller 408a that may include a first mirror image of the first predetermined pattern and a second embossing roller 408b that may include a second mirror image of the second predetermined pattern. The first predetermined pattern and the second predetermined pattern resist may nesting between the first surface and the second surface when wound to overlap or disposed to be adjacent to one another.

In block 706, the method 700 may include winding the embossed substrate at a second predetermined speed to create a wound and embossed substrate including a plurality of layers. Winding the embossed substrate may include controlling a first orbital gripper 510 to rotate when attached to a first end of the embossed substrate while simultaneously controlling a second orbital gripper 520 to rotate when attached to a second end of the embossed substrate.

In block 708, the method 700 may include separating the wound and embossed substrate 501b from the embossed substrate by cutting the embossed substrate to create a wound substrate structure. The wound and embossed substrate 501b is separated from the embossed substrate by a guillotine 506.

In block 710, the method 700 may include bonding the plurality of layers at one or more bond points. Bonding the plurality of layers may include applying a predetermined amount of pressure to the collapsed substrate structure at one or more predetermined locations to form one or more bonds between the plurality of layers. The predetermined amount of pressure may be applied at the one or more predetermined locations by moving one or more actuators 444 attached to one or more pins 446 such that the one or more actuators 444 apply pressure against one or more anvils or plates via the one or more pins 446 with the plurality of layers disposed between the one or more pins and the one or more anvils or plates.

In some embodiments, the method 700 may include collapsing the wound substrate to create a collapsed substrate structure.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art. This disclosure is intended to cover various modifications and equivalent arrangements included within the scope of the appended claims. Although specific terms are employed herein, they are used in a generic and descriptive sense only and not for purposes of limitation.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

As used herein, “recyclable” may refer to any product that is eligible for either curbside collection or for being accepted into recycling programs that use drop-off locations.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-45. (canceled)

46. An insulation product, comprising:
a first paper substrate forming a plurality of layers comprising:
a first layer comprising a first embossed pattern comprising a plurality of embossed lines defining a plurality of non-embossed portions of the first layer;
a second layer comprising a second embossed pattern comprising a plurality of protrusions formed in the second layer, wherein the first layer is disposed to overlap the second layer such that the first layer does not nest with itself or the second layer;
a second paper substrate disposed on a first side of the first paper substrate; and
a third paper substrate disposed on a second side of the first paper substrate opposite the first side,
wherein the first paper substrate is attached to the second paper substrate at one or more points.

47. The insulation product of claim 46, having an R-Value per inch of greater than 3.77.

48. An insulation product, comprising:
a first paper substrate forming a plurality of layers comprising:
a first layer;
a second layer comprising a second embossed pattern;
one or more fold lines disposed between the first layer and the second layer, wherein that the first layer overlaps with the second layer based on the one or more fold lines such that the second layer does not nest with itself or the first layer; and
a second paper substrate disposed on a first side of the first paper substrate,
wherein the first paper substrate is attached to the second paper substrate at one or more points.

49. The insulation product of claim 48, wherein the second embossed pattern comprise a plurality of second protrusions, wherein the second protrusions comprise a partial spherical shape.

50. The insulation product of claim 49, wherein the first layer is not embossed.

51. The insulation product of claim 49, wherein the first layer comprises a first embossed pattern different from the second embossed pattern.

52. The insulation product of claim 51, wherein the first embossed pattern comprises a plurality of embossed lines defining a plurality of non-embossed portions of the first layer.

53. The insulation product of claim 48, wherein the second paper substrate covers at least a portion of the first paper substrate.

54. The insulation product of claim 48, wherein a second paper substrate is disposed on a first side of the first paper substrate, and wherein a third paper substrate is disposed on a second side of the first paper substrate opposite the first side.

55. The insulation product of claim 54, wherein the third paper substrate covers at least a portion of the first paper substrate.

56. The insulation product of claim 48, having an R-Value per inch of greater than 3.77.

57. An insulation product, comprising:
a first paper substrate forming a plurality of layers comprising:
a first layer;
a second layer comprising a second embossed pattern;
one or more fold lines disposed between the first layer and the second layer, wherein that the first layer overlaps with the second layer based on the one or more fold lines and wherein the second layer with the second embossed pattern does not nest with itself or the first layer; and
a second paper substrate disposed on a first side of the first paper substrate.

58. The insulation product of claim 57, further comprising:
a second paper substrate disposed on a first side of the first paper substrate; and
wherein the first paper substrate is attached to the second paper substrate at one or more points with adhesive.

59. The insulation product of claim 57, wherein the second embossed pattern comprise a plurality of protrusions and the protrusions comprise at least a partial spherical shape.

60. The insulation product of claim 59, wherein the first layer is not embossed.

61. The insulation product of claim 57, wherein the first layer comprises a first embossed pattern different from the second embossed pattern.

62. The insulation product of claim 61, wherein the first embossed pattern comprises a plurality of embossed lines defining a plurality of non-embossed portions of the first layer.

63. The insulation product of claim 57, wherein the second paper substrate at least partially covers the first paper substrate.

64. The insulation product of claim 57, wherein a second paper substrate is disposed on a first side of the first paper substrate, and wherein a third paper substrate is disposed on a second side of the first paper substrate opposite the first side, and wherein the insulation product has an R-Value per inch of greater than 3.77.

65. The insulation product of claim 64, wherein the third paper substrate at least partially covers the first paper substrate.
